(19) United States
(12) Patent Application Publication
(10) Pub. No.: US 2026/0046814 A1
(43) Pub. Date: Feb. 12, 2026

(54) TOWARDS UE ID MAPPINGS FOR 5G SIDELINK RANGING AND POSITIONING

(71) Applicant: Telefonaktiebolaget LM Ericsson (publ), Stockholm (SE)

(72) Inventors: Zhang FU, Stockholm (SE); Richárd BÁTORFI, Budapest (HU); Juying GAN, Shanghai (CN); Monica WIFVESSON, Lund (SE); Cheng WANG, Shanghai (CN)

(21) Appl. No.: 19/100,656

(22) PCT Filed: Aug. 8, 2023
(86) PCT No.: PCT/IB2023/058016

§ 371 Date: Feb. 3, 2025

(30) Foreign Application Priority Data
Aug. 8, 2022 (WO) PCT/CN2022/110838

(51) Int. Cl. H04W 64/00; H04W 8/00; H04W 60/04; H04W 84/04; H04W 92/18

(52) U.S. Cl. CPC H04W 64/00; H04W 8/005; H04W 60/04; H04W 84/042; H04W 92/18

(57) ABSTRACT

Systems and methods for mapping User Equipment (UE) Identities (IDs), e.g., for sidelink ranging/positioning. In one embodiment, a method performed by a network node includes receiving, from a Network Function (NF) consumer, a service request including either: (a) a Subscription Permanent Identifier (SUPI) of a particular UE or (b) a Sidelink Ranging Application User Identity (SRAUID) and/or a Sidelink Ranging Discovery User Identity (SRDUID), of the particular UE. The method further includes sending, to the NF consumer, a response comprising either: (a) a SRAUID mapped to the SUPI of the particular UE and/or a SRDUID mapped to the SUPI of the particular UE, if the service request comprises SUPI of the particular UE, or (b) the SUPI mapped to the SRAUID and/or SRDUID of the particular UE, if the service request includes the SRAUID and/or SRDUID of the particular UE and/or the SRDUID of the particular UE.

### RELATED APPLICATIONS

This application claims the benefit of international patent application serial number PCT/CN2022/110838, filed Aug. 8, 2022, the disclosure of which is hereby incorporated herein by reference in its entirety.

### TECHNICAL FIELD

The present disclosure relates to sidelink ranging and positioning in a cellular communications system.

### BACKGROUND

In regard to terminology in sidelink ranging and positioning, 3rd Generation Partnership Project (3GPP) Technical Report (TR) 23.700-86 (see, e.g., V0.3.0) defines various terms as shown in the following excerpt from 3GPP TR 23.700-86:

### START EXCERPT FROM TR 23.700-86

Ranging: refers to the determination of the distance between two UEs or more UEs and/or the direction and/or relative positioning of one UE (i.e. Target UE) from another UE (i.e. Reference UE) via PC5 interface.

Reference UE: A UE who determines a reference plane and reference direction in the Ranging based service and Sidelink positioning.
NOTE 1: Reference UE is the same as Observer UE used in TR 22.855 [2].

Target UE: A UE whose distance, direction and/or position is measured comparing to the reference plane, reference direction and/or location of a Reference UE in the Ranging based service and Sidelink positioning.
NOTE 2: Any UE participating in the Ranging/Sidelink Positioning can be both a Target UE and a Reference UE and can switch roles in the same Ranging/Sidelink Positioning session.
Editor's note: Concerning Reference UE and Target UE, whether new name will be defined to differentiate with the term Reference UE and Target UE used in eLCS is FFS.

Assistant UE: A UE who provides assistance for Ranging/Sidelink Positioning when the direct ranging/Sidelink positioning between a Reference UE and a Target UE cannot be supported.

Located UE: A UE of which the location is known or is able to be known using Uu based positioning. A Located UE can be used to determine the location of a Target UE using Sidelink Positioning.
Editor's note: Change term Network assisted UE and Second UE to Located UE throughout the document.

Location Server UE: A UE offering location server functionality in lieu of LMF, for Sidelink Positioning and Ranging over Sidelink. It interacts with a Target UE, Reference UEs, Assistant UE and Located UEs as necessary in order to calculate the location of the Target UE.

Sidelink Positioning: Positioning UE using PC5.

Positioning: A functionality, which detects a geographical location and optionally, velocity (of e.g. a mobile terminal).

Relative position: An estimate of the UE position relative to other network elements or relative to other UEs.
Editor's note: Definition on the terminology of Ranging and Sidelink positioning will be aligned with RAN WGs, and will be revisited when there's any conclusion in RAN WGs.

### END EXCERPT FROM TR 23.700-86

3GPP TR 23.700-86 has Key Issue #3 about ranging/sidelink positioning device discovery, as shown in the following excerpt from 3GPP TR 23.700-86:

### START EXCERPT FROM TR 23.700-86

In most of the cases, the 2 or more UE(s) in a Ranging based service and sidelink positioning cannot always be aware of each other even when they are in proximity.

To enable a Reference observer UE and a target UE to be able to perform measurement and communicate for delivering measurement data, the UEs have to be discovered by each other first.

The discovery procedure is used for a UE to discover or to be discovered by other UE(s) in proximity over the PC5 interface with the aim of performing Ranging and Sidelink Positioning.

Reference UE and Target UE are 2 roles in the Ranging based service and Sidelink Positioning, in terms of who provides the reference plane and reference direction. Either one can be discovered by the other.

Ranging/Sidelink Positioning device discovery may be triggered at the UEs themselves and/or based on network instruction (e.g. under network monitoring, when, within which distance/angle or which UE(s) can be discovered).

Following aspects need to be addressed under this key issue:
1. How Reference UEs and Target UEs are discovered by each other to perform Ranging based service and Sidelink Positioning for the case of in coverage, partial coverage and out of coverage for both UE triggered and network triggered Ranging/Sidelink Positioning, with the following considerations:
   How one Target UE and one Reference UE are discovered by each other?
   How one Target UE and multiple Reference UEs are discovered by each other?
   How one Reference UE and multiple target UEs are discovered by each other?
NOTE 1: ProSe direct discovery procedure should be reused as much as possible.
2 How Ranging/Sidelink Positioning devices'discovery is triggered at UE based on network instruction for the cases of in coverage, partial coverage and out of coverage?
NOTE 2: It is assumed that both the Reference UE(s) and the target UE are Ranging/SL positioning capable.

### END EXCERPT FROM TR 23.700-863

Some solutions for Key Issue #3 described in 3GPP TR 23.700-86 are described in the following excerpts from 3GPP TR 23.700-86:

### START FIRST EXCERPT FROM TR 23.700-86

### 6.7 Solution #7: Network based UE Sidelink Positioning

### 6.7.1 Introduction

This solution relates the KI#5 and proposes a solution where the network perform the UE positioning estimation based on network assisted Sidelink positioning.

### 6.7.2 Functional Description

This solution addresses KI#5 for MT-LR case, and the following principles are used:
UE within the network coverage, either directly over Uu or via a L2 U2N relay, is in a location where Uu based positioning is not possible
MT-LR procedure is triggered by the network as specified in TS 23.273 [11] clause 6.1.
UE is requested to perform positioning measurements by the LMF
The UE check whether the UE can perform positioning measurements on other RAN nodes or needs to use Sidelink positioning methods. The UE determines that Uu based positioning is not possible and needs to perform Sidelink positioning. The UE search for another UE that is able to estimate it's own location based on Uu measurements and support Ranging service.
NOTE 1: The discovery of the second UE depends on solution for KI #3 “Ranging/Sidelink Positioning device discovery”
The UE performs ranging estimate measurements of the second UE and provides either the ranging estimate or the ranging measurements data to the LMF. The UE also include the UE ID of the second UE.
NOTE 2: LPP (TS 37.355 [10]) may need to be enhanced to support new measurement message to support Sidelink positioning.
When the network received the information from the UE, the network can use a known location of the second UE or trigger a new location estimate from the second UE. The LMF triggers any of the location procedures specified in TS 23.273 [11] clause 6.11 to estimate the second UE's position.
Based on the position estimate of the second UE, the LMF can estimate the UE position, the UE being the UE that the first positioning request was sent to.
NOTE 3: The RAN study on Sidelink Positioning will determine the accuracy of Sidelink position e.g. whether multilateration positioning estimate(s) are needed or not.

### 6.7.3 Procedures

### 6.7.3.1 Network based UE Sidelink Positioning estimation (MT-LR).

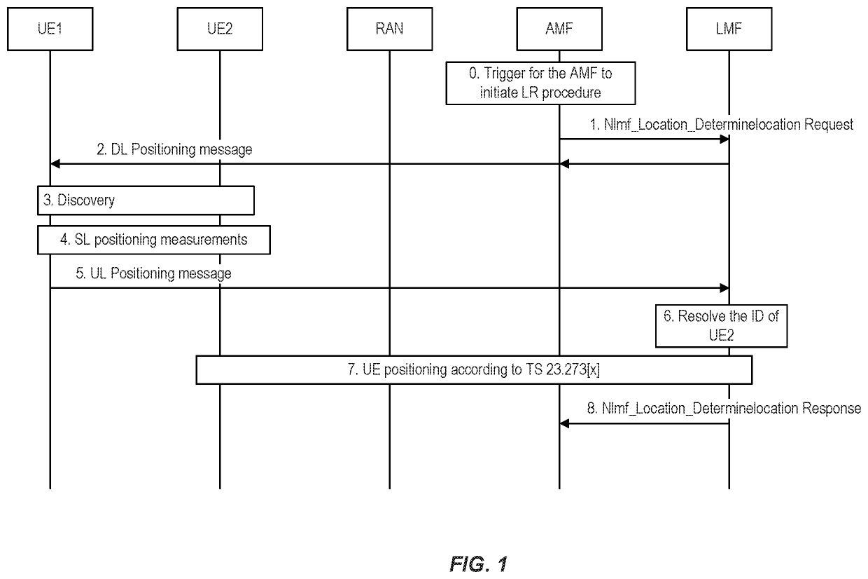

### REPRODUCED HEREIN AS FIG. 1

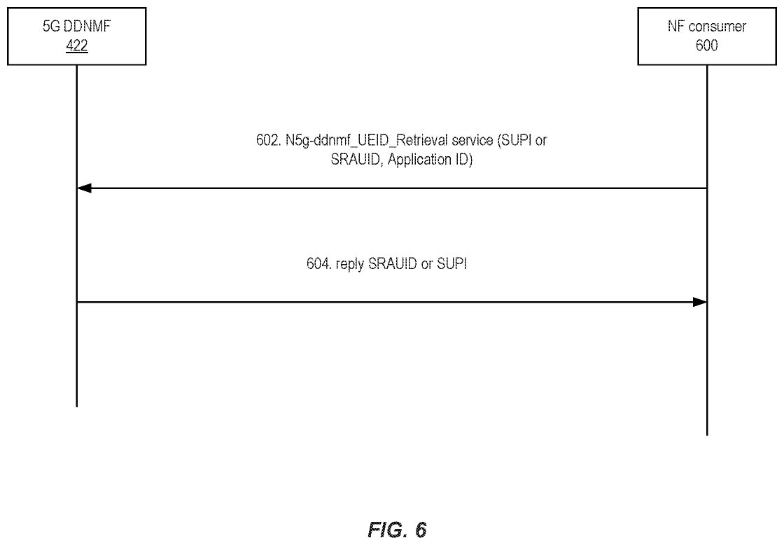

### FIG. 6.7.3.1-1: Network Based UE Sidelink Positioning estimation (MT-LR)

0. The AMF is triggered to initiate location reporting procedure for UE1 as specified in TS 23.273 [11]. UE1 may either be in network coverage and communicates over Uu, or UE1 uses a Layer-2 UE-to-Network Relay to communicate with the network. The Layer-2 UE-to-Network Relay can be the second UE or a different UE that can offer Layer-2 UE-to-Network service.
NOTE 1: UE1 and UE2 may be registered and served by different AMFs.
1. The AMF sends the initial request to the LMF as specified in TS 23.273 [11]
2. The LMF sends the DL Positioning message to the UE1 using the Namf_Communication_N1N2messageTransfer as specified in clause 6.11.1 of TS 23.273 [11].
3. The UE1 decides to perform discovery procedure to find a UE that supports sidelink positioning and Uu based measurements (e.g. because it has determined it is unable to perform legacy Uu positioning measurements). The UE1 selects UE2.
NOTE 2: The UE logic to determine to use sidelink positioning is based on UE implementation. E.g. the UE could determine that Uu positioning is not possible for instance based on the number of cells that UE1 can detect being limited.
NOTE 3: It is assumed that solutions for discovery addressing the KI#3 can used. During the discovery procedure UE1 will get the UE_ID of UE2 which supports positioning procedures defined in TS 23.273 [11]. The UE_ID is the ID that UE2 used during the ProSe discovery procedure.
4. The UE1 perform Ranging/Sidelink relative distance measurements to the UE2.
NOTE 4: It is assumed that solutions addressing KI#4 can used.
5. The UE1 send the UL Positioning message to the LMF. This message includes both the Ranging/Sidelink positioning data and the UE_ID of UE2.
6. The LMF resolves the received UE_ID of UE2 by querying the DDNMF and triggers the location determination of UE2. The LMF may need to query the UDM to find the AMF that is serving the UE2 to initiate the positioning procedures.
NOTE 4: It is assumed that the LMF uses the service based interface N5g-ddnmf for interaction with the DDNMF.
7. The LMF triggers the serving AMF to initiate the positioning procedure. The LMF receives from the AMF the LCS Correlation ID and cell-ID for UE2 and performs one or more of the positioning procedures described in clauses 6.11.1, 6.11.2 and 6.11.3 of TS 23.273 [11] to determine the location of UE2. The LMF determines the location of UE1 based on the SL positioning data received in step 5 and the location of UE2.
NOTE 5: UE1 mobility may impact the LMF location estimation of UE2. To reduce the impact the LMF may try to time synchronize the UE1 location measurements and the SL measurements or use time stamps and estimate the mobility based on mobility trajectory. This is a generic topic for all solution that use non-stationary devices that participates in the location estimation of another UE.
8. The LMF provides the UE1 location to the AMF as a response to the request in step 1.

### START SECOND EXCERPT FROM TR 23.700-86

### 6.21 Solution #21: Network Assisted Sidelink Positioning For Partial Coverage

### 6.21.1 General

This solution is to address KI#5.

A UE out of coverage may be a UE not registered to the network or a UE temporarily unreachable. It may be in a known area, e.g. a factory or a campus, or not be in a known area, an application server may want to know its accurate location.

When a UE is out of coverage, positioning directly over Uu is not possible, communication between the UE and 5GC is not possible, either.

When 5GC determines that a UE is out of network coverage, it can consider to use Network assisted Sidelink Positioning to estimate UE location.

Since Network assisted Sidelink Positioning requires Ranging/Sidelink positioning between the UE and a Network assisted UE, a Network assisted UE needs to be determined. Network assisted UE has to be in proximity of the UE out of coverage; however, UE should not be assumed to proactively discover a Network assisted UE, because it doesn't know when a location service request comes.

### 6.21.2 Functional Descriptions

A location service request for a UE may be sent to GMLC by an application server (via NEF) or a LCS client, and GMLC forwards the service request to an AMF. The serving AMF needs to be determined by the GMLC when UE is out of coverage.

UE out of coverage can be determined by GMLC or AMF, who will then triggers Network assisted Sidelink Positioning to locate a UE based on serving AMF address retrieval result or paging result:
Case 1: When Gmlc retrieves Amf address from the UDM With SUPI of This UE and no network address of the current serving AMF is returned
Case 2: When UE's Serving AMF identifies that UE is in CM-IDLE state and paging couldn't be successful

For Case 1, if Application server knows about the target area the UE is present, it provides in the LCS service request the target area to the GMLC, and the GMLC maps the target area into Cell ID/gNB ID/TAI and derives the serving AMF which can serve that area.

For Case 2, serving AMF is determined based on the successful retrieval of AMF address from the UDM.

The serving AMF of the UE/target area is responsible for discovery/selection the network assisted UE, which can be achieved in 2 steps:
1. Provision of network assisted UE candidates: AMF may be preconfigured with list of network assisted UE, assuming those network assisted UE are nomadic, or if UE provides its capability of being network assisted UE during registration, AMF stores it into UE contexts. AMF selects network assisted UE candidates from the preconfigured list or based on UE capability.
2. Selecting serving Network assisted UE(s) from the list of network assisted UE candidates: If target area is provided, AMF selects one or multiple network assisted UE(s) based on the target area identified by Cell ID/gNB ID/TAI. If last known cell ID of the target UE is provided, AMF selects one or multiple network assisted UE(s) based on the cell ID.

The AMF then selects an LMF supporting Network assisted Sidelink Positioning as the serving LMF of the selected network assisted UE and sends the LCS service request to the LMF with providing UE ID and one or multiple network assisted UE ID.

When both UE ID and one or multiple network assisted UE ID are received, the LMF performs Network assisted Sidelink Positioning, including:
Discovery of the UE by the one or multiple network assisted UE over PC5. LMF can decide to stop discovery when one or multiple network assisted UE has reported successfully discovery of the UE.
Measurement and deriving UE location from:
   Ranging/Sidelink positioning result/measurement data between UE and one or multiple network assisted UE.
   Uu positioning result/measurement data of one or multiple network assisted UE.

### 6.21.3 Procedures

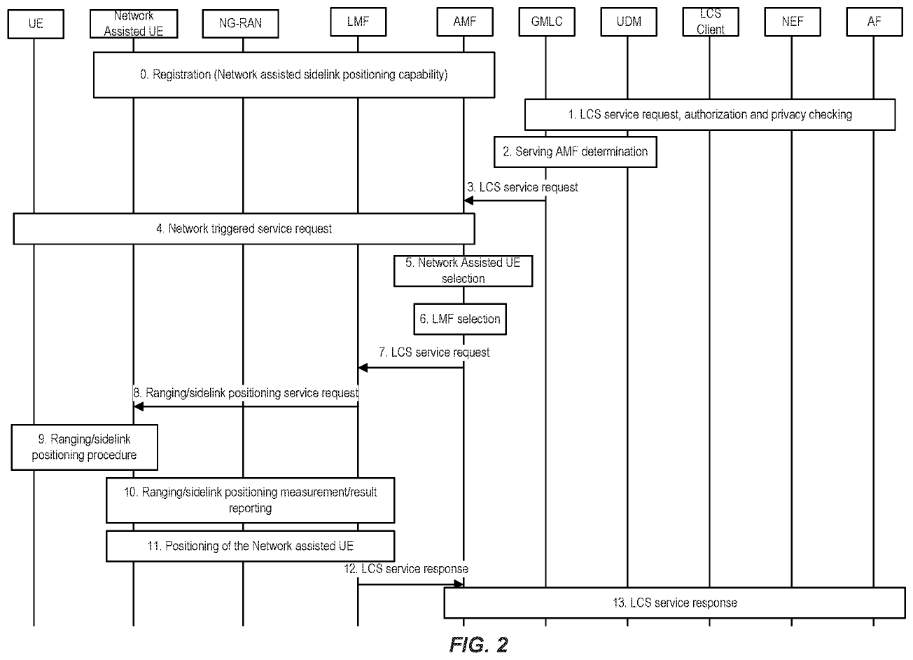

### REPRODUCED HEREIN AS FIGURE 2

### 6.21.3.2-1: Procedure of Network Assisted Sidelink Positioning for Partial Coverage

0. Network assisted UE provides its Network assisted Sidelink positioning capability in the registration request to the AMF, and AMF stores it in the UE context.
1. GMLC receives a LCS service request from the AF/LCS client, the request may include a target area the UE presents. GMLC checks service authorization and privacy with UDM.
2. GMLC retrieves serving AMF of target UE from UDM. If no AMF address is returned and a target area is provided in the LCS service request, GMLC determines to use Network assisted sidelink positioning to locate the target UE. GMLC maps the target area into Cell ID/gNB ID/TAI, based on which derives the serving AMF which can serve that area as the serving AMF of the network assisted UE. If an AMF address is returned, GMLC selects the AMF as the serving AMF of the target UE.
3. GMLC sends the LCS service request to the selected AMF, which includes the Cell ID/gNB ID/TAI of the target area if it is available.
NOTE: When the AMF is derived based on Cell ID/gNB ID/TAI identifying the target area and multiple AMFs are derived, the LCS service request may be sent to some or all AMFs.
4. If the UE is in CM IDLE state, the AMF initiates a network triggered Service Request procedure as defined in clause 4.2.3.3 of TS 23.502 [9] to establish a signalling connection with the UE. When the AMF is derived based on Cell ID/gNB ID/TAI identifying the target area, no UE state is available, this step is skipped.
5. If the UE couldn't be successfully paged at step 4, AMF determines to invoke network assisted sidelink positioning to locate the UE. AMF selects one or multiple network assisted UE based on UE capability, cell ID/gNB ID/TAI of the target area, the last known cell ID of the target UE and the pre-configuration information.
6. AMF selects a LMF capable of network assisted sidelink positioning.
7. AMF sends the LCS service request to the LMF which includes target UE ID and one or multiple network assisted UE ID(s)
Editor's note: The security issue, e.g. whether the selected list of network assisted UE is allowed to have the Ranging/SL positioning information of the target UE, is FFS, which will be evaluated in SA WG3.
8. When both UE ID and one or multiple network assisted UE ID(s) are received in the LCS service request, LMF sends the Ranging/Sidelink positioning request to one or multiple network assisted UE(s) to trigger the Ranging/Sidelink positioning procedure.
9. Network assisted UE triggers the Ranging/Sidelink positioning procedure, which includes the discovery and service operation procedure over PC5.
10. Network assisted UE reports the Ranging/Sidelink positioning measurement or result to the LMF. LMF may receive measurement or result reporting from multiple Network assisted UEs, LMF can determine whether to stop the further reporting from other Network assisted UEs based on QoS requirement or pre-configuration.
11. LMF triggers one or multiple procedures for the positioning of one or multiple network assisted UE. The LCS location estimation for the UE is generated based on the Ranging/Sidelink positioning result/measurement data between UE and one or multiple network assisted UE and Uu positioning result/measurement data of one or multiple network assisted UE.
12. LMF provides the LCS location estimation of the UE to the GMLC.
13. GMLC provides the LCS location estimation of the UE to the AF or LCS client.

### END EXCERPTS FROM TR 23.700-86

### SUMMARY

Systems and methods are disclosed for mapping User Equipment (UE) Identities (IDs), e.g., for sidelink ranging and positioning. In one embodiment, a method performed by a network node comprises receiving, from a Network Function (NF) consumer, a service request comprising either: (a) a Subscription Permanent Identifier (SUPI) of a particular UE or (b) a Sidelink Ranging Application User Identity (SRAUID) of the particular UE and/or a Sidelink Ranging Discovery User Identity (SRDUID) of the particular UE. The method further comprises sending, to the NF consumer, a response comprising either: (a) a SRAUID mapped to the SUPI of the particular UE and/or a SRDUID mapped to the SUPI of the particular UE, if the service request comprises SUPI of the particular UE, or (b) the SUPI mapped to the SRAUID and/or SRDUID of the particular UE, if the service request comprises the SRAUID and/or SRDUID of the particular UE and/or the SRDUID of the particular UE. In this manner, the UE can be identified by the network node and/or other network nodes regardless of whether SUPI or SRAUID/SRDUID is used.

In one embodiment, the service request comprises the SUPI of the particular UE and additional information comprising either or both of: an Application ID and a sidelink positioning service code, and the response comprises a SRAUID and/or a SRDUID mapped to the SUPI.

In one embodiment, the network node stores a mapping between the SUPI of the particular UE and the SRAUID and/or SRDUID of the particular UE.

In one embodiment, a Home Public Land Mobile Network (HPLMN) of the particular UE is different than a Public Land Mobile Network (PLMN) in which the network node is located, and the service request comprises the SUPI of the particular UE. In addition, the method further comprises sending the service request to a second network node in the HPLMN of the UE and receiving a response from the second network node, the response from the second network node comprising the SRAUID mapped to the SUPI of the particular UE and/or the SRDUID mapped to the SUPI of the particular UE.

In one embodiment, a HPLMN of the particular UE is different than a PLMN in which the network node is located, and the service request comprises the SRAUID and/or SRDUID of the particular UE. In addition, the method further comprises sending the service request to a second network node in the HPLMN of the UE and receiving a response from the second network node, the response from the second network node comprising the SUPI mapped to the SRAUID and/or SRDUID of the particular UE.

In one embodiment, the method further comprises, prior to receiving the service request, receiving, from the particular UE, a registration request comprising the SUPI of the particular UE and additional information comprising information that indicates a service associated to the registration request and an application ID and determining whether the particular UE is authorized to use the service. The method further comprises, responsive to determining that the particular UE is authorized to use the service, storing a mapping between the SUPI of the particular UE and the SRAUID and/or SRDUID of the particular UE, the SRAUID and/or SRDUID of the particular UE either being comprised in the registration request or generated by the network node.

In one embodiment, the SRAUID and/or SRDUID of the particular UE is comprised in the registration request. In another embodiment, the method further comprises generating the SRAUID and/or SRDUID of the particular UE. In one embodiment, the method further comprises sending a registration response to the particular UE, the registration response comprising SRAUID and/or SRDUID of the particular UE.

In one embodiment, the NF consumer is a Location Management Function (LMF).

In one embodiment, the service request is associated with a sidelink ranging or positioning procedure, and the particular UE is a sidelink positioning enabled UE for the sidelink ranging or positioning procedure.

In one embodiment, the network node is a network node that implements a Direct Discovery Name Management Function, DDNMF.

Corresponding embodiments of a network node are also disclosed. In one embodiment, a network node is adapted to receive, from a NF consumer, a service request comprising either: (a) a SUPI of a particular UE or (b) a SRAUID of the particular UE and/or a SRDUID of the particular UE. The network node is further adapted to send, to the NF consumer, a response comprising either: (a) a SRAUID mapped to the SUPI of the particular UE and/or a SRDUID mapped to the SUPI of the particular UE, if the service request comprises SUPI of the particular UE, or (b) the SUPI mapped to the SRAUID and/or SRDUID of the particular UE, if the service request comprises the SRAUID and/or SRDUID of the particular UE and/or the SRDUID of the particular UE.

In one embodiment, a network node comprises processing circuitry configured to cause the network node to receive, from a NF consumer, a service request comprising either: (a) a SUPI of a particular UE or (b) a SRAUID of the particular UE and/or a SRDUID of the particular UE. The processing circuitry is further configured to cause the network node to send, to the NF consumer, a response comprising either: (a) a SRAUID mapped to the SUPI of the particular UE and/or a SRDUID mapped to the SUPI of the particular UE, if the service request comprises SUPI of the particular UE, or (b) the SUPI mapped to the SRAUID and/or SRDUID of the particular UE, if the service request comprises the SRAUID and/or SRDUID of the particular UE and/or the SRDUID of the particular UE.

Embodiments of a method performed by a UE are also disclosed. In one embodiment, a method performed by a UE comprises sending, to a network node, a registration request comprising a SUPI of the UE and a SRAUID of the particular UE and/or a SRDUID of the particular UE.

Corresponding embodiments of a UE are also disclosed. In one embodiment, a UE is adapted to send, to a network node, a registration request comprising a SUPI of the UE and a SRAUID of the particular UE and/or a SRDUID of the particular UE.

In one embodiment, a UE comprises one or more transmitters, one or more receivers, and processing circuitry associated with the one or more transmitters and the one or more receivers. The processing circuitry is configured to cause the UE to send, to a network node, a registration request comprising a SUPI of the UE and a SRAUID of the particular UE and/or a SRDUID of the particular UE.

In one embodiment, a method performed by a UE comprises sending, to a network node, a registration request comprising a SUPI of the UE and receiving, from the network node, a registration response comprising a SRAUID assigned to the UE and/or a SRDUID assigned to the UE.

Corresponding embodiments of a UE are also disclosed. In one embodiment, a UE is adapted to send, to a network node, a registration request comprising a SUPI of the UE and receive, from the network node, a registration response comprising a SRAUID assigned to the UE and/or a SRDUID assigned to the UE.

In one embodiment, a UE comprises one or more transmitters, one or more receivers, and processing circuitry associated with the one or more transmitters and the one or more receivers. The processing circuitry is configured to cause the UE to send, to a network node, a registration request comprising a SUPI of the UE and receive, from the network node, a registration response comprising a SRAUID assigned to the UE and/or a SRDUID assigned to the UE.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a reproduction of FIG. 6.7.3.1-1 from 3rd Generation Partnership Project (3GPP) Technical Report (TR) 23.700-86;

FIG. 2 is a reproduction of FIG. 6.21.3.2-1 from 3GPP TR 23.700-86;

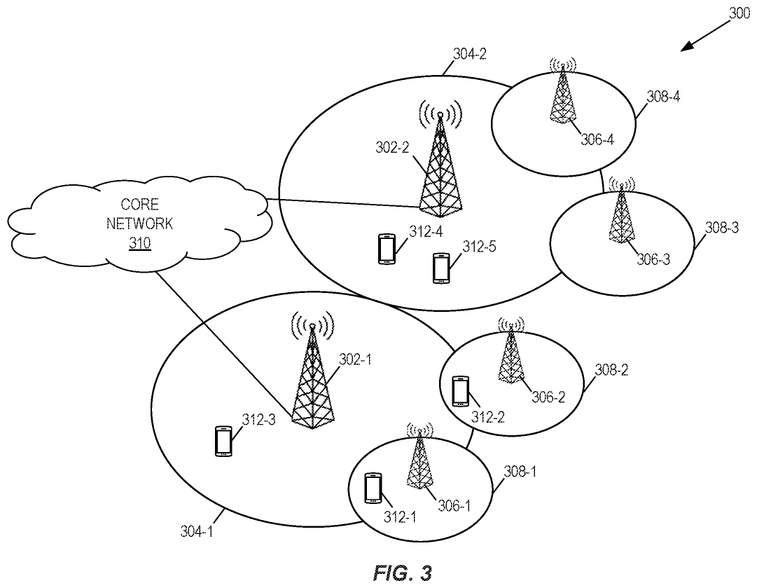

FIG. 3 illustrates one example of a cellular communications system according to some embodiments of the present disclosure;

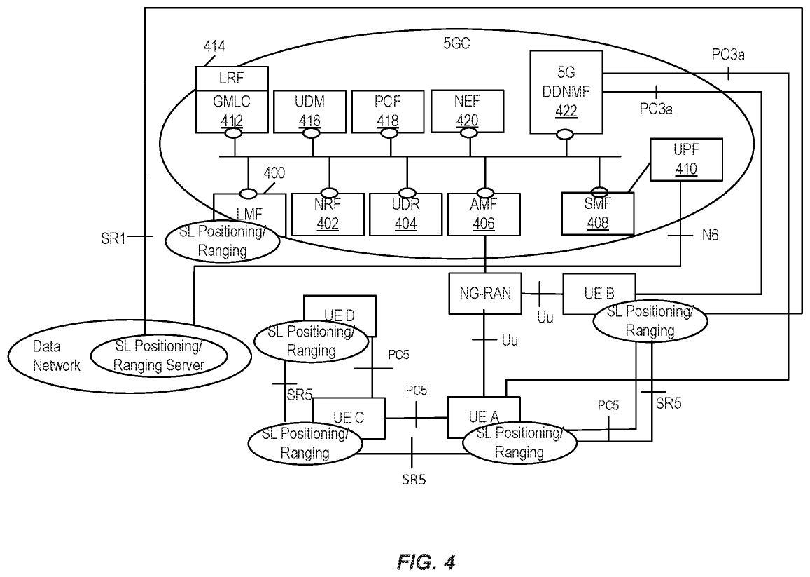

FIG. 4 illustrates an example embodiment in which the cellular communication system of FIG. 3 is a Fifth Generation (5G) System (5GS) and, more specifically, illustrates the reference architecture for sidelink positioning and ranging-based services for non-roaming and same Public Land Mobile Network (PLMN) operation currently defined in 3GPP TR 23.700-86;

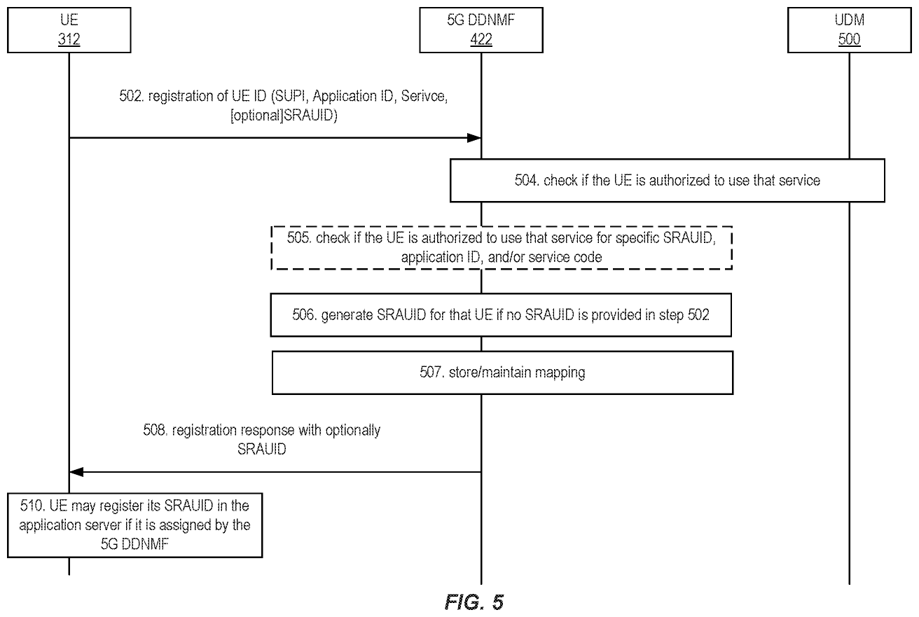

FIGS. 5, 6, 7, 8, 9, and 10 illustrate example embodiments of the present disclosure;

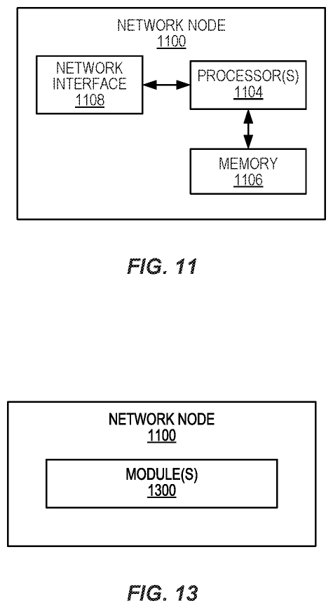

FIG. 11 is a schematic block diagram of a network node according to some embodiments of the present disclosure;

FIG. 12 is a schematic block diagram that illustrates a virtualized embodiment of the network node of FIG. 11 according to some embodiments of the present disclosure;

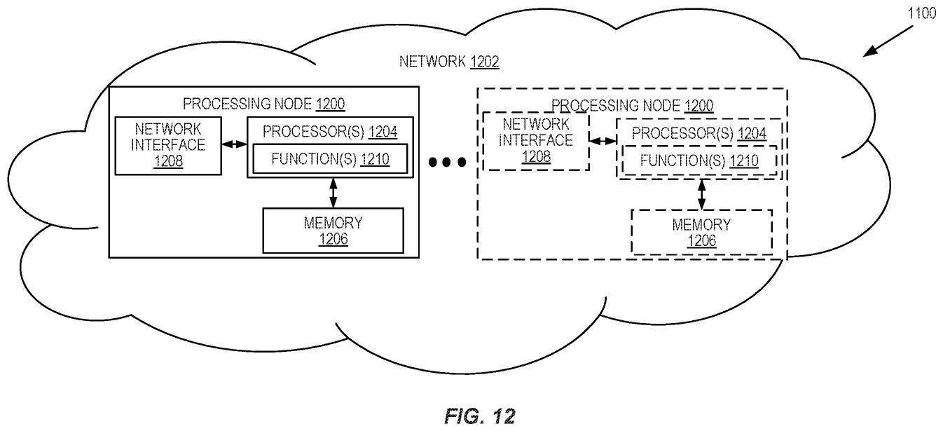

FIG. 13 is a schematic block diagram of the network node of FIG. 11 according to some other embodiments of the present disclosure;

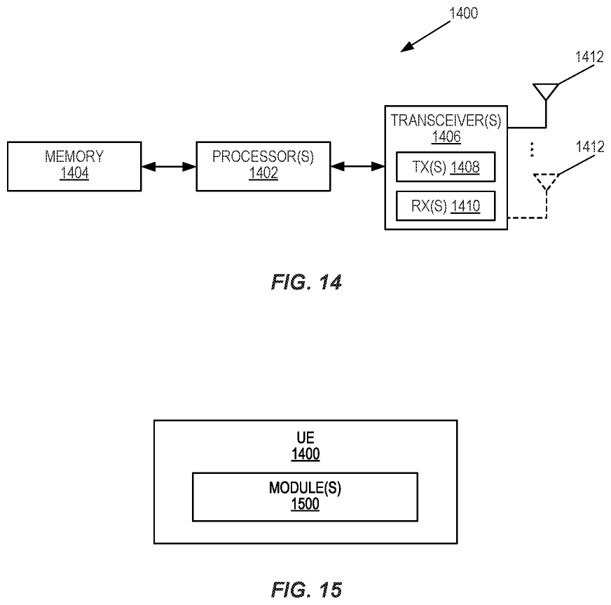

FIG. 14 is a schematic block diagram of a User Equipment device (UE) according to some embodiments of the present disclosure; and

FIG. 15 is a schematic block diagram of the UE of FIG. 14 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

In current 3GPP specifications, the Location Management Function (LMF) uses the Subscription Permanent Identifier (SUPI) to identify a User Equipment (UE). However, when a UE does device discovery via PC5 reference point, SUPI is not used in the discovery message. Instead, Application Layer or Service Layer User Identity (ID) is usually used in the PC5 discovery message. Therefore, if the LMF wants to inform the reference UE ID to the target UE, it cannot provide SUPI. The LMF needs to provide the Application Layer User ID of the reference UE to the target UE or provide the Application Layer User ID of the target UE to the reference UE as shown in Solution #21 above. The problem then is there is currently no procedure that enables the LMF to get the Application Layer User ID of a UE.

In another scenario, the target UE may select the reference UE by itself and send the reference UE ID to the LMF as shown in Solution #7, step 5. In this case, the problem is that there is currently no procedure that enables the LMF find the SUPI of the reference UE from its Application Layer User ID. Solution #7 mentions that the Fifth Generation (5G) Direct Discovery Name Management Function (DDNMF) can help, but no details are given.

Systems and methods for addressing the above and/or other challenges are disclosed. In one embodiment, a new service of 5G DDNMF is disclosed which provides ID mappings between SUPI and application layer or service layer user ID. In particular, regarding sidelink ranging/positioning, in one embodiment, a UE uses a SideLink Ranging Application User ID (SRAUID) in the PC5 discovery message. In one embodiment, the SRAUID is assigned by an Application server. In another embodiment, the SRAUID is assigned by the 5G DDNMF. In one embodiment, a UE registers or requests its SRAUID to/from the 5G DDNMF.

Embodiments of the solution(s) described herein provide a number of advantages over existing solutions. For example, embodiments of the solution(s) described herein enable an LMF to identify a UE when the UE does device discovery via PC5 reference point (i.e., via a sidelink).

FIG. 3 illustrates one example of a cellular communications system 300 in which embodiments of the present disclosure may be implemented. In the embodiments described herein, the cellular communications system 300 is a 5G system (5GS) including a Next Generation RAN (NG-RAN) and a 5G Core (5GC); however, the embodiments disclosed herein may be used in any cellular communications system that utilizes discovery via sidelink. In this example, the RAN includes base stations 302-1 and 302-2, which in the 5GS include NR base stations (gNBs) and optionally next generation eNBs (ng-eNBs) (e.g., LTE RAN nodes connected to the 5GC), controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or RRHs, or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5GS is referred to as the 5GC. The base stations 302 (and optionally the low power nodes 306) are connected to the core network 310.

The base stations 302 and the low power nodes 306 provide service to wireless communication devices 312-1 through 312-5 in the corresponding cells 304 and 308. The wireless communication devices 312-1 through 312-5 are generally referred to herein collectively as wireless communication devices 312 and individually as wireless communication device 312. In the following description, the wireless communication devices 312 are oftentimes UEs, but the present disclosure is not limited thereto. FIG. 4 illustrates a wireless communication system represented as a 5G network architecture composed of core Network Functions (NFs). FIG. 4 can be viewed as one particular implementation of the system 300 of FIG. 3. In particular, FIG. 4 illustrates an embodiment of the system 300 in accordance with the reference architecture for sidelink positioning and ranging-based services for non-roaming and same Public Land Mobile Network (PLMN) operation, in accordance with FIG. 4.3.1-1 of 3GPP TR 23.700-86. Note that this is only an example. For instance, the system 300 may alternatively use one of the other reference architectures defined in 3GPP TR 23.700-86 for inter-PLMN operations or inter-PLMN operation with roaming.

As illustrated in FIG. 4, the system 300 includes UEs 312 (referred to as UE A, UE B, UE C, and UE D) and respective PC5 interfaces (i.e., sidelinks) between them as shown. In this example, UE A and UE B have Uu interfaces to the RAN (e.g., to respective base stations 302). As illustrated, the core network 310 includes, in this example, various NFs including a Location Management Function (LMF) 400, a NRF 402, a UDR 404, an AMF 406, an SMF 408, a UPF 410, a GMLC 412 together with an LRF 414, a UDM 416, a PCF 418, a NEF 420, and a 5G DDNMF 422.

Note that an NF may be implemented either as a network element on a dedicated hardware, as a software instance running on a dedicated hardware, or as a virtualized function instantiated on an appropriate platform, e.g., a cloud infrastructure.

In the following sections, details are provided about how the 5G DDNMF 422 provides a service to map SUPI to the Application Layer/Service Layer User ID. Sidelink (SL) ranging is used as the example use case. In particular, in the first section below, embodiments related to how the 5G DDNMF 422 sets up the association between the SUPI and Application Layer/Service Layer User ID are described. In the second section below, embodiments related to how the 5G DDNMF 422 provides the service to map SUPI to the Application Layer/Service Layer User ID are described. In the third section below, SL ranging is used as use case and embodiments related to how the LMF 400 uses such service to get UE SUPI or Application Layer/service Layer ID are described.

### Application Layer/Service Layer User ID Registration to 5G DDNMF

In one embodiment, in the SL ranging use case, the UE 312 uses a SideLink Ranging Application User ID (SRAUID) in the PC5 discovery message. Note that the term “SRAUID” is used herein as an example; however, this ID may can use any name. As such, as used herein, the term “SRAUID” should be understood to refer to this ID, regardless of the actual name given to this ID. The SRAUID could be either assigned by the application server, or it could be assigned by the PCF 418 or 5G DDNMF 422.

FIG. 5 illustrates a procedure in accordance with one example embodiment of the present disclosure. This procedure involves the UE 312, the 5G DDNMF 422, and a UDM 500. The steps of the procedure of FIG. 5 are described below.

Step 502: The UE 312 sends a registration request to the 5G DDNMF 422 with its SUPI, Application ID, and/or SL positioning service code. If the UE 312 gets its SRAUID from an AF (Application function, Application Server) or the PCF 418, the UE 312 registers the SRAUID in the 5G DDNMF 422. In other words, if the UE 312 gets its SRAUID from an AF or the PCF 418, the UE 312 includes the SRAUID in the registration request. In this regard, the SRAUID is an optional element of the registration request. If the SRAUID should be assigned by the 5G DDNMF 422, the UE 312 does not include any SRAUID in the registration request.

Step 504: The 5G DDNMF 422 gets UE subscription data for the UE 312 from the UDM 500 and, using the UE subscription data, checks if the UE 312 is authorized to use the SL ranging/positioning service.

Step 505 (Optional): The 5G DDNMF 422 may contact the PCF 418 or AF to check if the UE 312 is authorized to use the SL ranging/positioning service for a specific SRAUID, Application ID, and/or SL positioning service code.

For example, if the SRAUID is assigned by the AF, then the 5G DDNMF 422 may use a Naf_ProSe_DiscoveryAuthorization request to the AF, including the SRAUID, Application ID and optionally SL positioning service code. If the SRAUID is a valid user ID to use the SL ranging/positioning service, the AF will respond with the ProSe Discovery UE ID (PDUID) (defined in 3GPP TS 23.304) that the UE 312 registered in the AF. If the PDUID from the AF matches the one from the PCF 418, then 5G DDNMF 422 take the SRAUID as a valid SRAUID that is associated with that UE 312.

Step 506: If steps 504 and 505 are OK, if 5G DDNMF 422 should assign an SRAUID to the UE 312, then 5G DDNMF 422 generates an SRAUID for the UE 312. Note that the 5G DDNMF 422 can generate an SRAUID for all Applications using SL ranging/positioning, or it could generate an SRAUID per application.

Step 507: Regardless of whether the SRAUID is generated by the 5G DDNMF 422 or provided by the UE 312 in the registration request of step 502, the 5G DDNMF 422 maintains a mapping between the UE SUPI and the SRAUID, optionally with the Application ID and/or SL positioning service code.

Step 508: The 5G DDNMF 422 sends a response to the UE 312, indicating if the registration is OK or rejected. Also, if the 5G DDNMF 422 generated the SRAUID in step 506, the 5G DDNMF 422 may also send the generated SRAUID to the UE 312 in the response.

Step 510: The UE 312 may register its SRAUID in the application server if the ID is assigned by the 5G DDNMF 422.

If SRAUID is allocated by the PCF 418 or the 5GDDNMF 422, it may contain information about a Home PLMN (HPLMN) of the UE 312.

In an alternative embodiment, another User ID beside SRAUID, e.g., SideLink Ranging Discovery User ID (SRDUID), is allocated by the PCF 418 or 5G DDNMF 422. This User ID could be used within 5GC and used in PC5 interface for SL positioning and containing the HPLMN info of the UE. In this regard, in all steps above, SRAUID can be replaced with SRAUID and/or SRDUID.

The 5G DDNMF 422 maintains the mapping between the UE SUPI and the SRAUID and/or SRDUID.

### New Service of 5G DDNMF to Map SUPI to the Application Layer/Service Layer User ID

In one embodiment, a new service of the 5G DDNMF 422 is provided to map SUPI to the Application Layer/Service Layer User ID. This new service is referred to herein as a N5g-ddnmf_UEID_Retrieval service; however, this name is only an example. Other names may be used for this service.

FIG. 6 illustrates a procedure for the new service when the UE 312 belongs to the same PLMN of the 5G DDNMF 422, in accordance with one embodiment of the present disclosure. The procedure involves the 5G DDNMF 422 and an NF consumer 600. The steps of the procedure are described below.

When the UE belongs to the PLMN of the 5G DDNMF 422, this means the 5G DDNMF 422 should have the mapping between SUPI and SRAUID by itself, i.e., it does not need to ask a 5G DDNMF of another PLMN.

Step 602: The NF consumer 600 of the N5g-ddnmf_UEID_Retrieval service sends a request to the 5G DDNMF 422. If the NF consumer 600 wants to get the UE SUPI, it includes SRAUID and the Application ID and/or SL positioning service code in the request. If the NF consumer 600 wants to get the SRAUID of the UE 312, it includes SUPI and the Application ID and/or SL positioning service code in the request.

Step 604: The 5G DDNMF 422 sends the SRAUID or SUPI depending on the request.

An alternative embodiment, from steps above, SRAUID is replaced with SRAUID and/or SRDUID.

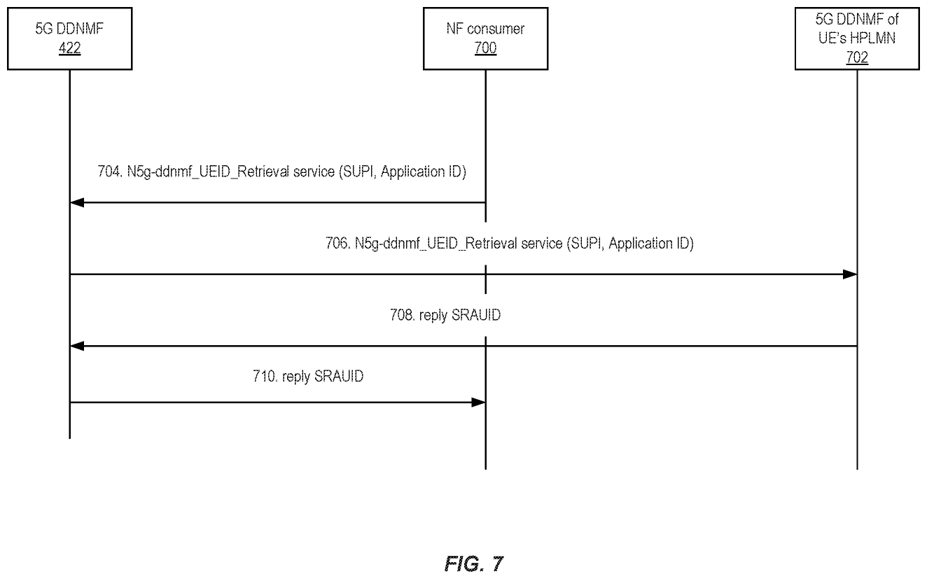

FIG. 7 illustrates a procedure in accordance with another example embodiment in which an NF consumer 700 wants to get the UE SRAUID, but the UE's Home PLMN (HPLMN) is different from the PLMN of the current 5G DDNMF 422. This procedure involves the (current) 5G DDNMF 422, the NF consumer 700, and another 5G DDNMF 702 of the UE's HPLMN. The steps of the procedure are described below.

Step 704: The 5G DDNMF 422 receives a N5g-ddnmf_UEID_Retrieval request, but the SUPI included in the request belongs to another PLMN. This means the current 5G DDNMF 422 does not have the UE context or ID mappings.

Step 706: The 5G DDNMF 422 sends the N5g-ddnmf_UEID_Retrieval request to the 5G DDNMF 702 of the UE's HPLMN.

Step 708 and 710: The 5G DDNMF 702 of the UE's HPLMN sends back the UE's SRAUID to the first 5G DDNMF 422. The first 5G DDNMF 422 sends back the SRAUID to the NF consumer 700.

An alternative embodiment, from steps above, SRAUID is replaced with SRAUID and/or SRDUID.

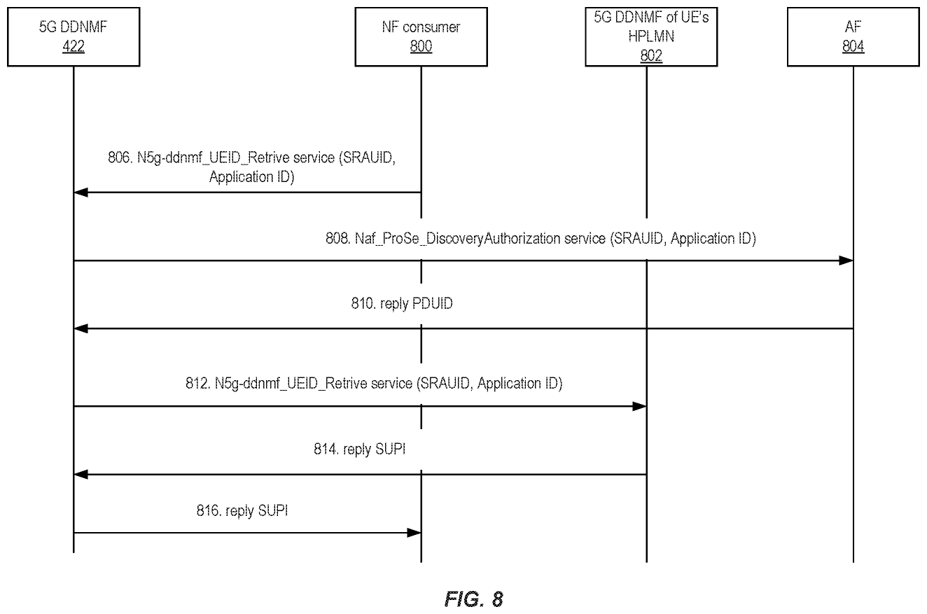

FIG. 8 illustrates a procedure in accordance with another example embodiment in which an NF consumer 800 wants to get the UE SUPI, but the UE's HPLMN is different from the PLMN of current 5G DDNMF 422. The procedure involves the 5G DDNMF 422, the NF consumer 800, a 5G DDNMF 802 of the UE's HPLMN, and an AF 804. The steps of the procedure are described below.

Step 806: The 5G DDNMF 422 receives a N5g-ddnmf_UEID_Retrieval request, but it cannot recognize the SRAUID in the request. It may happen that the corresponding UE 312 belongs to another PLMN, so the current 5G DDNMF 422 does not have the UE context or ID mappings.

Step 808: The 5G DDNMF 422 sends the Naf_ProSe_Discovery Authorization request to the application server/AF 804, where the request includes the SRAUID.

Naf_ProSe_DiscoveryAuthorization is defined in TS 23.304.

Step 810: If the application server has the context of the SRAUID, it will reply to the 5G DDNMF 422 with the PDUID (defined in TS 23.304).

Step 812: If the 5G DDNMF 422 gets a PDUID from the application server, it can get the UE's HPLMN information. Using this information, the 5G DDNMF 422 sends the N5g-ddnmf_UEID_Retrieval request to the 5G DDNMF 802 of the UE's HPLMN, with PDUID and/or SRAUID.

Step 814 and 816: The 5G DDNMF 802 of the UE's HPLMN sends back the UE's SUPI to the first 5G DDNMF 422. The first 5G DDNMF 422 sends back the SUPI to the NF consumer 800.

An alternative embodiment, if SRAUID contains HPLMN information or if SRDUID is received in step 806, instead of steps 808-810, the 5G DDNMF 422 contacts the 5G DDNMF 802 of HPLMN directly and sends the N5g-ddnmf_UEID_Retrieval request to the 5G DDNMF 802 of the UE's Home PLMN (HPLMN).

### Using the N5g-ddnmf_UEID_Retrieval Service in SL Ranging/Positioning Scenario

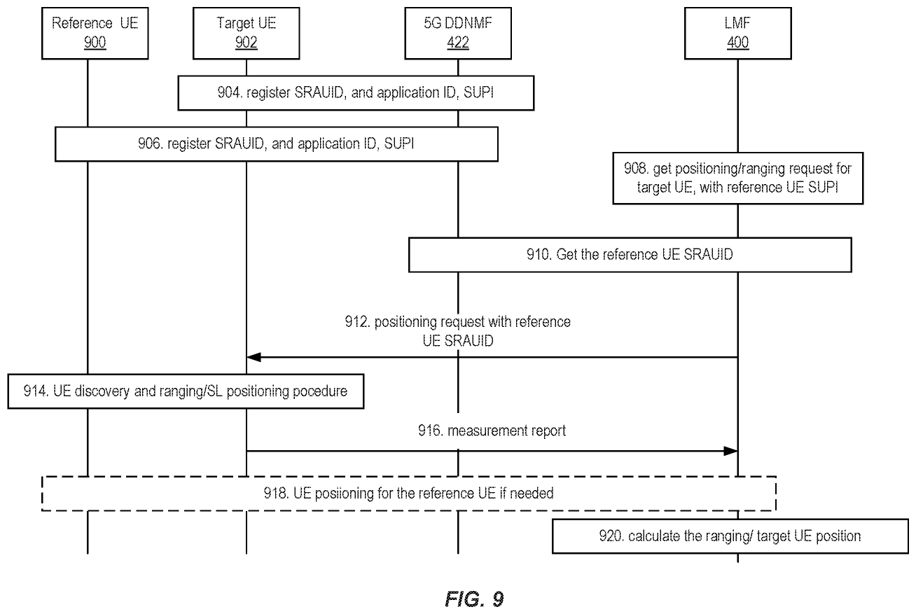

FIG. 9 illustrates an example embodiment of a procedure in which the LMF 400 receives a positioning/ranging request for a target UE 902. The LMF 400 also has information that indicates that the SL ranging/positioning should be done with a particular reference UE 900. The steps of this procedure are described below.

Steps 904 and 906: The target UE 902 and the 5G DDNMF 422 perform the registration procedure of FIG. 5 for the target UE 902. The details are the same as described above. Likewise, the reference UE 900 and the 5G DDNMF 422 perform the registration procedure of FIG. 5 for the UE 900.

Step 908: The LMF 400 receives a positioning/ranging request for the target UE 902. The LMF 400 also has information that indicates that the SL ranging/positioning should be done with the reference UE 900. But since the LMF 400 only has the SUPI of the reference UE 900, the LMF 400 needs to get the SRAUID of the reference UE 900.

Step 910: The LMF 400, as the N5g-ddnmf_UEID_Retrieval service consumer, retrieves the SRAUID of the reference UE 900 as explained above, e.g., with respect to FIGS. 6, 7, or 8.

Step 912: The LMF 400 sends the SL ranging/positioning request to the target UE 902 with the reference UE's SRAUID.

Steps 914-920: These steps are shown only for the completeness of the procedure. The details are out of the scope of the present disclosure.

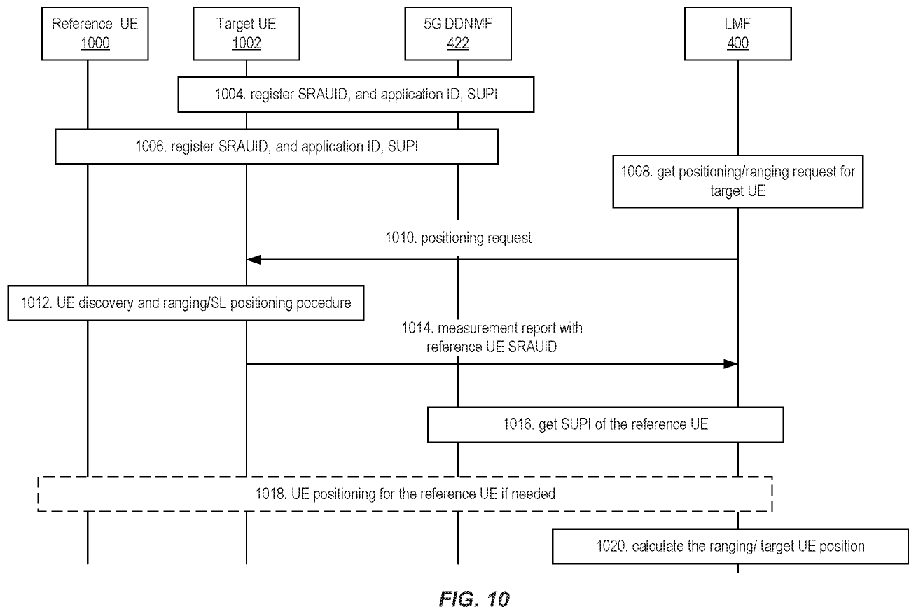

FIG. 10 illustrates a procedure in accordance with another example embodiment in which the LMF 400 receives a positioning/ranging request for a target UE 1002, but it does not have the information of the reference UE 1000. The steps of the procedure are described below.

Steps 1004 and 1006: The target UE 1002 and the 5G DDNMF 422 perform the registration procedure of FIG. 5 for the target UE 1002. The details are the same as described above. Likewise, the reference UE 1000 and the 5G DDNMF 422 perform the registration procedure of FIG. 5 for the UE 1000.

Steps 1008-1014: Similar to steps 1-5 in Solution #7 of TR 23.700-86.

Step 1016: The LMF 400, as the N5g-ddnmf_UEID_Retrieval service consumer, retrieves the SUPI of the reference UE 1000 as explained above, e.g., with respect to FIGS. 6, 7, or 8.

Steps 1018 and 1020: These steps are shown only for the completeness of the procedure. The details are out of the scope of the present disclosure.

### Further Description

FIG. 11 is a schematic block diagram of a network node 1100 according to some embodiments of the present disclosure. Optional features are represented by dashed boxes. The network node 1100 may be, for example, a core network node that implements a NF (e.g., 5G DDNMF 422, LMF 400, NF consumer 600, NF consumer 700, 5G DDNMF 702, NF consumer 800, 5G DDNMF 802, or the like) or a network node that implements all or part of the functionality of an NF (e.g., all or part of the functionality of the 5G DDNMF 422, LMF 400, NF consumer 600, NF consumer 700, 5G DDNMF 702, NF consumer 800, 5G DDNMF 802, or the like described herein). As illustrated, the network node 1100 includes a one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. The one or more processors 1104 operate to provide one or more functions of the network node 1100 as described herein (e.g., one or more functions of the 5G DDNMF 422, LMF 400, NF consumer 600, NF consumer 700, 5G DDNMF 702, NF consumer 800, or 5G DDNMF 802 described herein). In some embodiments, the function(s) are implemented in software that is stored, e.g., in the memory 1106 and executed by the one or more processors 1104.

FIG. 12 is a schematic block diagram that illustrates a virtualized embodiment of the network node 1100 according to some embodiments of the present disclosure. Again, optional features are represented by dashed boxes. As used herein, a “virtualized” network node is an implementation of the network node 1100 in which at least a portion of the functionality of the network node 1100 is implemented as a virtual component(s) (e.g., via a virtual machine(s) executing on a physical processing node(s) in a network(s)). As illustrated, in this example, the network node 1100 includes one or more processing nodes 1200 coupled to or included as part of a network(s) 1202. Each processing node 1200 includes one or more processors 1204 (e.g., CPUs, ASICs, FPGAS, and/or the like), memory 1206, and a network interface 1208. In this example, functions 1210 of the network node 1100 described herein (e.g., one or more functions of the 5G DDNMF 422, LMF 400, NF consumer 600, NF consumer 700, 5G DDNMF 702, NF consumer 800, or 5G DDNMF 802 described herein) are implemented at the one or more processing nodes 1200 or distributed across the two or more processing nodes 1200 in any desired manner. In some particular embodiments, some or all of the functions 1210 of the network node 1100 described herein are implemented as virtual components executed by one or more virtual machines implemented in a virtual environment(s) hosted by the processing node(s) 1200.

In some embodiments, a computer program including instructions which, when executed by at least one processor, causes the at least one processor to carry out the functionality of the network node 1100 or a node (e.g., a processing node 1200) implementing one or more of the functions 1210 of the network node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the network node 1100 according to some other embodiments of the present disclosure. The network node 1100 includes one or more modules 1300, each of which is implemented in software. The module(s) 1300 provide the functionality of the network node 1100 described herein. This discussion is equally applicable to the processing node 1200 of FIG. 12 where the modules 1300 may be implemented at one of the processing nodes 1200 or distributed across multiple processing nodes 1200.

FIG. 14 is a schematic block diagram of a wireless communication device 1400 according to some embodiments of the present disclosure. As illustrated, the wireless communication device 1400 includes one or more processors 1402 (e.g., CPUs, ASICS, FPGAs, and/or the like), memory 1404, and one or more transceivers 1406 each including one or more transmitters 1408 and one or more receivers 1410 coupled to one or more antennas 1412. The transceiver(s) 1406 includes radio-front end circuitry connected to the antenna(s) 1412 that is configured to condition signals communicated between the antenna(s) 1412 and the processor(s) 1402, as will be appreciated by on of ordinary skill in the art. The processors 1402 are also referred to herein as processing circuitry. The transceivers 1406 are also referred to herein as radio circuitry. In some embodiments, the functionality of the wireless communication device 1400 described above may be fully or partially implemented in software that is, e.g., stored in the memory 1404 and executed by the processor(s) 1402. Note that the wireless communication device 1400 may include additional components not illustrated in FIG. 14 such as, e.g., one or more user interface components (e.g., an input/output interface including a display, buttons, a touch screen, a microphone, a speaker(s), and/or the like and/or any other components for allowing input of information into the wireless communication device 1400 and/or allowing output of information from the wireless communication device 1400), a power supply (e.g., a battery and associated power circuitry), etc.

In some embodiments, a computer program including instructions which, when executed by at least one processor, causes the at least one processor to carry out the functionality of the wireless communication device 1400 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the wireless communication device 1400 according to some other embodiments of the present disclosure. The wireless communication device 1400 includes one or more modules 1500, each of which is implemented in software. The module(s) 1500 provide the functionality of the wireless communication device 1400 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a network node, the method comprising:
receiving from a Network Function, NF, consumer, a service request comprising either:
a Subscription Permanent Identifier, SUPI, of a particular User Equipment, UE; or
one or both of a Sidelink Ranging Application User Identity, SRAUID, of the particular UE and a Sidelink Ranging Discovery User Identity, SRDUID, of the particular UE;
sending, to the NF consumer, a response comprising either:
one or both of a SRAUID mapped to the SUPI of the particular UE and a SRDUID mapped to the SUPI of the particular UE, if the service request comprises SUPI of the particular UE; or
one or both of the SUPI mapped to the SRAUID and the SRDUID of the particular UE, if the service request comprises one or more of the SRAUID and the SRDUID of the particular UE; and
prior to receiving the service request:
receiving, from the particular UE, a registration request comprising the SUPI of the particular UE and additional information comprising information that indicates a service associated to the registration request and an application identity, ID;
determining whether the particular UE is authorized to use the service; and
responsive to determining that the particular UE is authorized to use the service:
storing a mapping between the SUPI of the particular UE and one or both of the SRAUID and SRDUID of the particular UE, one or both of the SRAUID and the SRDUID of the particular UE either being comprised in the registration request or generated by the network node; and
the one or both of the SRAUID and SRDUID of the particular UE being comprised in the registration request.

2. The method of claim 1, wherein:
the service request comprises the SUPI of the particular UE and additional information comprising either or both of: an Application ID and a sidelink positioning service code; and
the response comprises one or both of a SRAUID and a SRDUID mapped to the SUPI.

3. The method of claim 1, wherein the network node stores a mapping between the SUPI of the particular UE and the one or both of the SRAUID and SRDUID of the particular UE.

4. The method of claim 1 wherein a Home Public Land Mobile Network, HPLMN, of the particular UE is different than a Public Land Mobile Network, PLMN, in which the network node is located, the service request comprises the SUPI of the particular UE and the method further comprises:
sending the service request to a second network node in the HPLMN of the UE and receiving a response from the second network node the response from the second network node comprising one or both of the SRAUID mapped to the SUPI of the particular UE and the SRDUID mapped to the SUPI of the particular UE

5. The method of claim 1, wherein a Home Public Land Mobile Network, HPLMN, of the particular UE is different than a Public Land Mobile Network, PLMN, in which the network node is located, the service request comprises one or both of the SRAUID and SRDUID of the particular UE and the method further comprises:
sending the service request to a second network node in the HPLMN of the UE and receiving a response from the second network node the response from the second network node comprising the SUPI mapped to one or both of the SRAUID and SRDUID of the particular UE

6. (canceled)

7. (canceled)

8. The method of claim [[6]] 1, further comprising generating one or both of the SRAUID and SRDUID of the particular UE

9. The method of claim 8, further comprising sending a registration response to the particular UE the registration response comprising one or both of the SRAUID and/or and SRDUID of the particular UE

10. The method of claim 1, wherein the NF consumer is a Location Management Function, LMF,

11. The method of claim 1, wherein the service request is associated with a sidelink ranging or positioning procedure, and the particular UE is a sidelink positioning enabled UE for the sidelink ranging or positioning procedure.

12. The method of claim 1, wherein the network node is a network node that implements a DDNMF.

13. (canceled)

14. (canceled)

15. A network node comprising processing circuitry configured to cause the network node to:
·receive from a Network Function, NF, consumer a service request comprising either:
O a Subscription Permanent Identifier, SUPI, of a particular User Equipment, UE, or
one or both of a Sidelink Ranging Application User Identity, SRAUID, of the particular UE and a Sidelink Ranging Discovery User Identity, SRDUID, of the particular UE ·send to the NF consumer a response comprising either:
O one or both of a SRAUID mapped to the SUPI of the particular UE and a SRDUID mapped to the SUPI of the particular UE if the service request comprises SUPI of the particular UE or
the SUPI mapped to one or both of the SRAUID and SRDUID of the particular UE if the service request comprises one or both of the SRAUID and SRDUID of the particular UE prior to receiving the service request: and receive, from the particular UE, a registration request comprising the SUPI of the particular UE and additional information comprising information that indicates a service associated to the registration request and an application identity, ID;
determine whether the particular UE is authorized to use the service; and
responsive to determining that the particular UE is authorized to use the service:
store a mapping between the SUPI of the particular UE and the one or both of the SRAUID and SRDUID of the particular UE, the one or both of the SRAUID and SRDUID of the particular UE either being comprised in the registration request or generated by the network node;
the one or both of the SRAUID and SRDUID of the particular UE being adapted to be comprised in the registration request.

16. The network node of claim 15, wherein the service request comprises the SUPI of the particular UE and additional information comprising either or both of: an Application ID and a sidelink positioning service code; and
the response comprises one or both of a SRAUID and a SRDUID mapped to the SUPI.

17. -19. (Cancelled).

20. A method performed by a User Equipment, UE, the method comprising:
·sending to a network node a registration request comprising:
O a Subscription Permanent Identifier, SUPI, of the UE and 0 one or both of a Sidelink Ranging Application User Identity, SRAUID, of the particular UE and a Sidelink Ranging Discovery User Identity, SRDUID, of the particular UE and ·receiving, from the network node, a registration response comprising one or both of a Sidelink Ranging Application User Identity, SRAUID, assigned to the UE and a Sidelink Ranging Discovery User Identity, SRDUID, assigned to the UE.

21. -24. (Cancelled).

25. A User Equipment, UE, comprising:
one or more transmitters;
one or more receivers; and
processing circuitry associated with the one or more transmitters and the one or more receivers, the processing circuitry configured to cause the UE to:
send to a network node a registration request comprising a Subscription Permanent Identifier, SUPI, of the UE and receive from the network node a registration response comprising one or both of a Sidelink Ranging Application User Identity, SRAUID, assigned to the UE and a Sidelink Ranging Discovery User Identity, SRDUID, assigned to the UE
